(19) United States
(12) Patent Application Publication
(10) Pub. No.: US 2026/0038474 A1
(43) Pub. Date: Feb. 5, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: OSAMU SHIGETA, TOKYO (JP); KAREN MURATA, TOKYO (JP); TSUTOMU FUZAWA, TOKYO (JP); YASUYUKI KOGA, TOKYO (JP); YURI NAKANO, TOKYO (JP); KENTARO YAMAZAKI, TOKYO (JP); KENTARO KIMURA, TOKYO (JP)

(21) Appl. No.: 19/101,242

(22) PCT Filed: Jun. 22, 2023
(86) PCT No.: PCT/JP2023/023065

§ 371 Date: Feb. 4, 2025

(30) Foreign Application Priority Data
Aug. 10, 2022 (JP) 2022-128401

(51) Int. Cl. G10K 11/178; G06F 16/68; G06F 16/683

(52) U.S. Cl. CPC G10K 11/17823; G06F 16/683; G06F 16/686

(57) ABSTRACT

In order to achieve the object described above, an information processing apparatus according to an embodiment of the present technology includes a controller. The controller controls ambient external sound around a user on the basis of metadata related to the external sound, the metadata being added to content played back according to user information regarding the user. This makes it possible to provide high-quality listening experience. Further, when content, such as narration or notice sound, that is desired to be heard by a user is played back, audio ducking is performed with respect to external sound, and this enables the content to be played back without being affected by the external sound. Further, experience intendedly utilizing external sound can also be provided.

### TECHNICAL FIELD

The present technology relates to an information processing apparatus, an information processing method, and a program that can be applied to, for example, digital noise canceling.

### BACKGROUND ART

Patent Literature 1 discloses a noise canceling headphone that includes a function of noise canceling using a plurality of noise canceling modes tailored for an external environment, and a function of automatically selecting an optimal mode according to a state of ambient noise, the noise canceling headphone including a noise analyzer that analyzes a frequency component of a noise signal obtained by converting sound collected by a microphone into an electric signal, the noise analyzer analyzing a noise signal at all times when the noise canceling function and the function of automatically selecting an optimal mode are being performed. This results in a user listening to, for example, music in a good listening environment at all times by switching to an optimal mode being automatically performed when there is a change in the state of ambient noise (for example, paragraphs [0013] to [0025] of the specification and FIG. 1 in Patent Literature 1).

### CITATION LIST

### Patent Literature

Patent Literature 1: Japanese Patent Application Laid-open No. 2016-174376

### DISCLOSURE OF INVENTION

### Technical Problem

There is a need for such a technology that makes it possible to provide high-quality listening experience by reducing a level of ambient environmental sound.

In view of the circumstances described above, it is an object of the present technology to provide an information processing apparatus, an information processing method, and a program that make it possible to provide high-quality listening experience.

### Solution to Problem

In order to achieve the object described above, an information processing apparatus according to an embodiment of the present technology includes a controller.

The controller controls ambient external sound around a user on the basis of metadata related to the external sound, the metadata being added to content played back according to user information regarding the user.

In the information processing apparatus, ambient external sound around a user is controlled on the basis of metadata related to the external sound, the metadata being added to content played back according to user information regarding the user. This makes it possible to provide high-quality listening experience.

The metadata may include at least one of a parameter related to sound pressure, a parameter related to a sound effect, a parameter related to stereophony, a parameter related to mixing, a label name given to the type of sound, or a parameter related to a direction of a sound source.

The controller may perform at least one of control based on the metadata to reduce sound pressure of the external sound, control on the sound effect according to the content, or control on a position of a sound source of the external sound.

The parameter related to stereophony may include a position of a sound source of the content and the position of the sound source of the external sound. In this case, the controller may perform control such that the position of the sound source of the content and the position of the sound source of the external sound do not overlap.

The controller may control sound pressure according to the type of the external sound on the basis of the metadata.

The label name may include sound of great danger for the user. In this case, the controller may perform control such that sound pressure of the great-danger sound is increased and such that sound pressure of the external sound other than the great-danger sound is reduced.

The label name may include at least one of sound of talks, sound of great danger for the user, announcement sound, a voice of a particular person, or sound suitable for the content. In this case, the controller may perform control such that sound pressure of at least one of the sound of talks, the great-danger sound, the announcement sound, the voice of the particular person, or the sound suitable for the content is increased and such that sound pressure of external sound other than at least one of the sound of talks, the great-danger sound, the announcement sound, or the voice of the particular person is reduced.

When the type of sound corresponds to sound of great danger for the user, the controller may be controlled on the basis of the metadata such that the sound is heard from a direction in which the sound is situated.

The controller may control sound pressure according to a direction of a sound source of the external sound on the basis of the metadata.

The direction of the sound source may include a region in front of the user and a region outside of a field of view of the user. In this case, the controller may perform control such that sound pressure of sound provided from the region in front of the user is increased and such that sound pressure of sound provided from the region outside of the field of view is reduced.

The metadata may include control on an application that enables a plurality of users to remotely have a talk with each other. The controller may execute or stop the application on the basis of a distance between the users of the plurality of the users.

When the distance between the users of the plurality of the users is less than a specified threshold, the controller may stop the application, and may perform control such that sound pressure of the external sound including voices of the plurality of the users is increased.

The information processing apparatus may further include a metadata controller that dynamically controls the metadata on the basis of at least one of device information regarding a device of the user or the user information.

The device information may include at least one of an application executed by the device, the remaining battery life of the device, or capacity of the device.

The user information may include at least one of an intention of the user, a position of the user, or behavior of the user.

The intention of the user includes the type of sound desired by the user. The controller may perform control such that sound pressure of the sound desired by the user is increased and such that sound pressure of the external sound other than the sound desired by the user is reduced.

The controller may perform control on the basis of the position of the user such that sound pressure of the external sound corresponding to an environment around the user is increased and such that sound pressure of the external sound other than the external sound corresponding to the environment around the user is reduced.

The controller may change the metadata on the basis of at least one of an intention of the user, a position of the user, or behavior of the user.

An information processing method according to an embodiment of the present technology includes controlling ambient external sound around a user on the basis of metadata related to the external sound, the metadata being added to content played back according to user information regarding the user.

A program according to an embodiment of the present technology causes a computer system to perform a process including controlling ambient external sound around a user on the basis of metadata related to the external sound, the metadata being added to content played back according to user information regarding the user.

### BRIEF DESCRIPTION OF DRAWINGS

FIG. 1 schematically illustrates an example of an information processing system.

FIG. 2 is a block diagram of an example of a configuration of the information processing system.

FIG. 3 is a block diagram of an example of a configuration of an external sound controller.

FIG. 4 is a flowchart illustrating an example of external sound control.

FIG. 5 is a block diagram of another example of the configuration of the external sound controller.

FIG. 6 is a block diagram of another example of the configuration of the external sound controller.

FIG. 7 schematically illustrates an example of control on external sound that is performed by direction separation.

FIG. 8 is a block diagram of another example of the configuration of the information processing system.

FIG. 9 is a block diagram of another example of the configuration of the external sound controller.

FIG. 10 schematically illustrates control performed on stereophony.

FIG. 11 is a flowchart illustrating an example of control performed to switch between a teleconference and a proximity talk.

FIG. 12 schematically illustrates a graphical user interface (GUI) used to create a waveform for noise canceling.

### MODE(S) FOR CARRYING OUT THE INVENTION

Embodiments according to the present technology will now be described below with reference to the drawings.

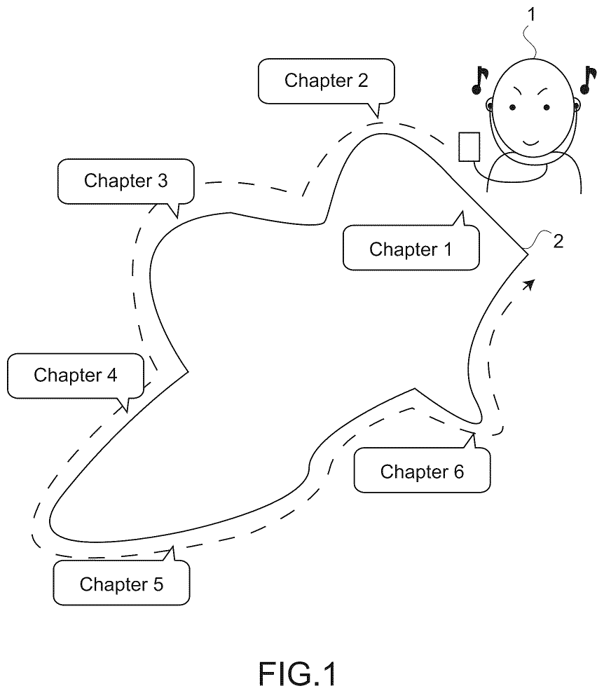

FIG. 1 schematically illustrates an example of an information processing system according to the present technology.

The present embodiment is intended for Sound AR (registered trademark), which provides auditory augmented reality (AR) experience by overlaying sound in a virtual world on sound in a real world. As illustrated in FIG. 1, a user 1 wears, for example, open-ear-type earphones, and this enables the user 1 to have experience in listening to specified content played back when the user 1 arrives at a specified location.

For example, the user 1 walks around a theme park 2 in which a story can be experienced vicariously, and can hear, through earphones, various kinds of sound such as lines spoken by characters in the story, background music, environmental sound, and sound effects linked to movement of the user 1. Further, for example, in FIG. 1, narration (such as a chapter 1) of the story is played back or sound effects are reproduced on the basis of position information regarding a position of the user 1 when the user 1 arrives at a specific location.

Note that the sound effects linked to movement of the user 1 include various kinds of sound depending on behavior of the user 1, such as character-specific footsteps along with walk (footsteps) of the user 1, and footsteps of treading on snow in a scene with accumulated snow in the story. In addition, sound effects linked to, for example, movement of a hand of the user 1 or orientation of a head of the user 1, or sound effects such as 3D audio effects for which a position at which the sound effect is provided is controlled, may be provided. The sound effect linked to movement of the user 1 is not limited to the examples described above, and may be a sound effect other than the sound effects described above.

In other words, sound of content includes all of sounds used to provide a greater sense of immersion. Further, the sound of content also includes sound obtained by those sounds being combined discretionarily to be arranged in a layered formation.

Further, sound other than the sound of content is referred to as external sound. Examples of the external sound include traveling sounds of a car and a train, footsteps and talks of a person other than the user, and sound produced by the user 1. In other words, the examples of the external sound include sound that interrupts sound of content, sound that blocks a sense of immersion into content, and environmental sound in the real world.

In the present embodiment, a device (earphones) worn by the user 1 includes a digital noise canceling (DNC) function. DNC is a technology used to digitalize noise collected using a microphone built in a device such as a headphone or earphones and to produce antiphase sound that provides an effect of canceling the noise. An external sound controller described later suppresses external sound that interrupts sound of content. This results in suppressing external sound in a noisy state, and in properly providing sound (content), such as narration or notice sound, that is desired by the user 1. Note that a noise canceling approach other than DNC may be adopted.

Note that earphones worn by the user 1 are not limited, and any device such as a headphone may be used. For example, canal earphones or a neck-band speaker may be used. Further, a device that does not include a microphone or DNC may be adopted. Furthermore, for example, a hearing aid or a sound collector may be adopted.

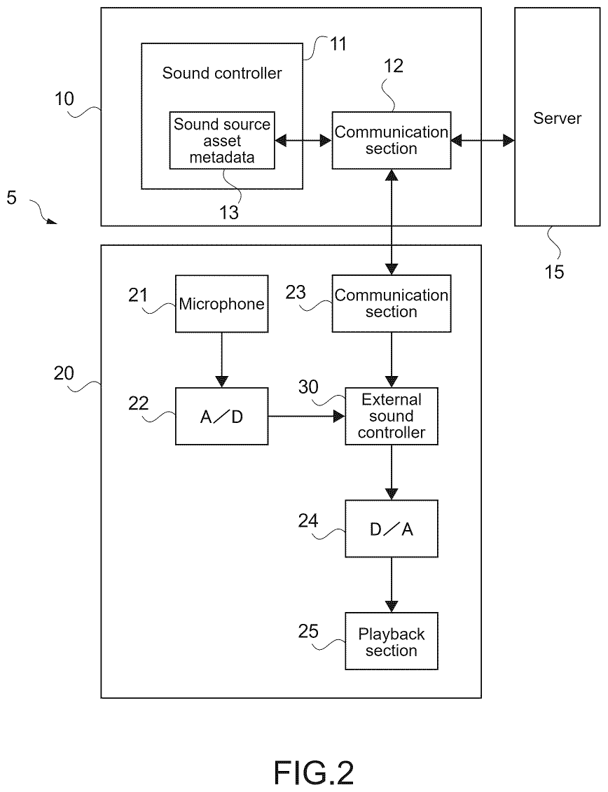

FIG. 2 is a block diagram of an example of a configuration of an information processing system 5.

As illustrated in FIG. 2, the information processing system 5 includes a mobile terminal 10, a server 15, and earphones 20.

The mobile terminal 10 includes a sound controller 11 and a communication section 12.

The sound controller 11 controls playback of content. In the present embodiment, the sound controller 11 reproduces sound sources of preset content on the basis of position information regarding a position of the mobile terminal 10 (the user 1). Note that stereophonic processing, and dynamic acoustic processing (such as generation of footsteps) linked to a sensor are assumed to be performed on sound sources with which content is played back.

The communication section 12 outputs information to a communication section 23 of the earphones 20. In the present embodiment, content played back by the sound controller 11, and sound source asset metadata (hereinafter referred to as metadata) 13 added to the content are output, and the output metadata 13 is transmitted to the earphones 20 through the communication section 12. A specific example of the metadata will be described later.

The server 15 can download, for example, sound data related to the above-described content by communicating with the communication section 12 of the mobile terminal 10. Further, the server 15 transmits the metadata added to the content to the sound controller 11 through the communication section 12. In addition, the server 15 may be used for the purpose of, for example, subscribing to music services.

The earphones 20 include a microphone 21, an A/D 22, the communication section 23, an external sound controller 30, a D/A 24, and a playback section 25.

The microphone 21 collects ambient external sound around the user 1. The A/D 22 converts, into a digital signal, an analog signal obtained by sound being collected by the microphone 21. In the present embodiment, the signal obtained by the conversion is output to the external sound controller 30.

The communication section 23 receives information such as metadata from the communication section 12 of the mobile terminal 10. In the present embodiment, the communication section 23 receives content played back by the sound controller 11, and the metadata 13, and outputs the received content and metadata 13 to the external sound controller 30.

The external sound controller 30 controls a degree of combining an amount of capturing external sound and sound sources of content, on the basis of the preset metadata 13 transmitted by the communication section 12 of the mobile terminal 10 and received by the communication section 23 of the earphones 20.

The playback section 25 play backs content controlled by the external sound controller 30 and recreates a waveform for canceling external sound. For example, the playback section 25 recreates a 2ch waveform generated by the external sound controller 30 and obtained by conversion into an analog signal being performed by the D/A 24.

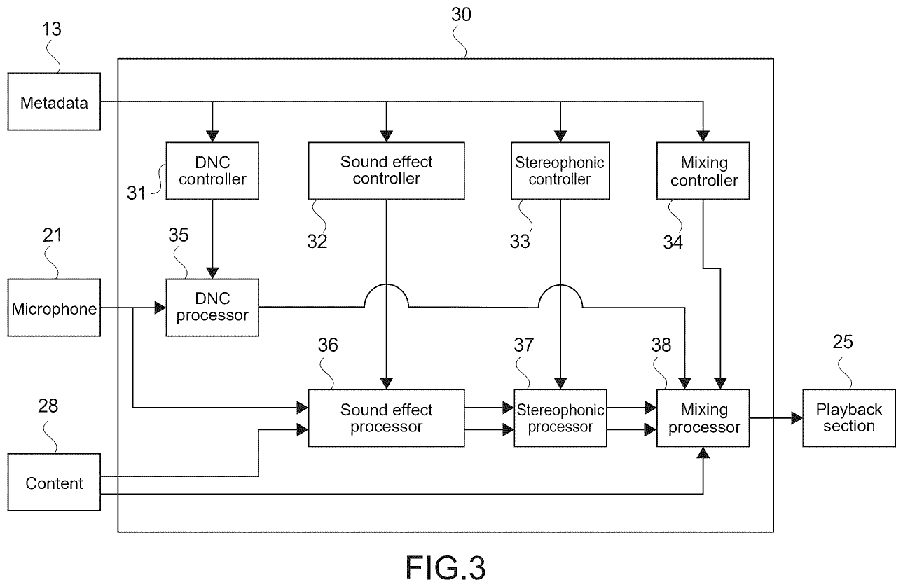

FIG. 3 is a block diagram of an example of a configuration of the external sound controller 30.

As illustrated in FIG. 3, the external sound controller 30 includes a DNC controller 31, a sound effect controller 32, a stereophonic controller 33, a mixing controller 34, a DNC processor 35, a sound effect processor 36, a stereophonic processor 37, and a mixing processor 38.

The DNC controller 31 controls a degree of adapting DNC on the basis of the metadata 13.

On the basis of the metadata 13, the sound effect controller 32 determines a sound effect adapted for external sound acquired by the microphone 21. Examples of the sound effect include processes of equalizer, fade-in, fade-out, and beamforming.

On the basis of the metadata 13, the stereophonic controller 33 determines a method for adapting stereophony for a waveform of external sound acquired by the microphone 21. In the present embodiment, control is performed such that localization positions for external sound and content are different and sounds are enhanced or levels of the sounds are reduced at the respective localization positions. For example, control is performed such that sounds can be distinguished when sound sources are reproduced at the same time, such as in the case of the cocktail party effect due to stereophony.

The mixing controller 34 controls mixing on the basis of the metadata 13.

In the present embodiment, examples of the metadata 13 include information used for a degree of reducing a level of external sound, information used for sound effect processing, information used for stereophonic control, and information used for mixing control.

For example, to what extent sound pressure (dB) is to be reduced is set according to content with respect to the degree of reducing a level of external sound. Further, for example, which of the sound effects such as an EQ parameter, a fading parameter, a comp parameter, and a reverb parameter is to be adapted is set according to content with respect to the sound effect processing. With respect to the stereophonic control, how a position (X, Y, Z), a pose (qx, qy, qz, qw), a specific parameter for stereophony, and the like are controlled is set according to content. With respect to the mixing control, a degree of mixing, for example, an external sound canceling waveform, a waveform of content, and an external sound capturing waveform is set according to content.

With respect to a degree of adapting DNC controlled by the DNC controller 31, the DNC processor 35 performs processing on external sound acquired by the microphone 21. This results in generating a waveform for canceling external sound, and in being able to mix virtual sound (content) while capturing the external sound according to a scene. For example, the degree of adapting DNC is set to a value between 0% and 100%. When the degree of adaptation is 0%, the DNC is not adapted, and an external sound capturing mode (also referred to as an ambient sound mode) in which external sound can be heard is started. When the degree of adaptation is 100%, a noise canceling mode is started, and external sound is canceled. The degree of adaptation may be dynamically changed on the side of the earphones 20 according to, for example, the type of ambient external sound or an environment in which a user is present, or may be appropriately set by a user through, for example, an app on the side of the mobile terminal 10.

Relative to a waveform of external sound and a waveform of sound of content 28, the sound effect processor 36 provides sound effects determined by the sound effect controller 32. This results in controlling external sound in real time. This makes it possible to crossfade external sound and content, and to make sound noticeable or reduce a level of the sound by performing EQ processing on external sound according to a scene. In other words, the quality of experience can be improved by external sound and content being linked to each other.

The stereophonic processor 37 performs stereophonic processing on an external sound capturing waveform and a waveform of sound of content 28, where processing has been performed by the sound effect processor 36 with respect to the external sound capturing waveform and the waveform of sound of content 28. This results in arranging external sound in a fixed position that is different from a fixed position of content. This makes it possible to reproduce external sound and play back content at the same time, and this enables the user 1 to selectively listen to the external sound and the content. For example, the user 1 can listen to content while listening to a voice of a person who is next to the user 1 and is having a talk. A parameter such as the interaural time difference (ITD), the interaural level difference (ILD), or the head-related transfer function (HRTF) may be used for the stereophonic processing.

The mixing processor 38 mixes waveforms on the basis of a degree of mixing waveforms controlled by the mixing controller 34. In the present embodiment, the mixing processor 38 mixes, on the basis of metadata, three waveforms that are an external sound canceling waveform output by the DNC processor 35, an external sound capturing waveform output by the sound effect processor 36 and the stereophonic processor 37, and a waveform of sound of content 28. Note that the present embodiment is not limited to DNC and a noise canceling function of a specified approach may be adopted, although DNC is taken as an example in the present embodiment.

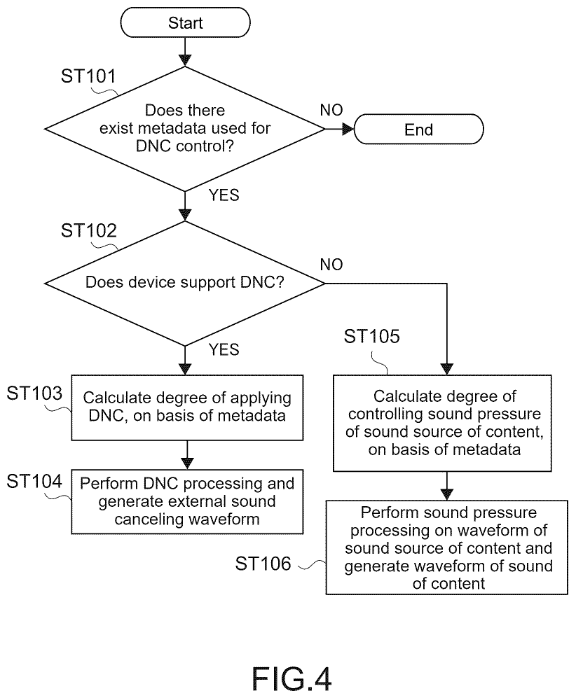

FIG. 4 is a flowchart illustrating an example of external sound control.

A user starts a dedicated application when, for example, the user enters, for example, the theme park 2 in which Sound AR (registered trademark) can be experienced. At this point, it is determined whether there is the metadata 13 used for DNC control with respect to the application (Step 101). For example, the metadata 13 is installed on the sound controller 11 of the mobile terminal 10 when the application is downloaded.

When there is the metadata 13 (YES in Step 101), it is determined whether a device (the earphones 20) of the user 1 supports DNC (Step 102).

When the device supports DNC (YES in Step 102), the DNC controller 31 calculates a degree of applying DNC, on the basis of the metadata 13 (Step 103). Further, the DNC processor 35 performs DNC processing, and an external sound canceling waveform is generated (Step 104).

Note that a method for canceling external sound using DNC is not limited. Control may be performed by a normalized value of 0 or 1, control may be performed using an absolute value of, for example, dB, or control may be performed such that a sound pressure is maintained at a specified sound pressure or less.

When the device does not support DNC (NO in Step 102), the external sound controller 30 calculates a degree of controlling a sound pressure of a sound source of content (Step 105). The external sound controller 30 performs sound pressure processing on a waveform of sound of content 28, and the waveform of sound of content 28 is generated (Step 106).

In other words, when the device does not support DNC, a waveform of sound of content 28 is controlled according to a parameter used for a sound effect, stereophony, or mixing, instead of controlling noise canceling or a degree of capturing external sound.

Note that an offset for a degree of applying DNC may be provided in response to an operation being performed by a user. In other words, a degree of capturing external sound may be adjustable according to an intention of a user.

### Modifications

The embodiments according to the present technology are not limited to the examples described above, and various modifications are made thereto. Note that, in modifications described below, descriptions of a configuration and an operation that are similar to those of the external sound controller 30 described in the embodiment above are omitted or simplified.

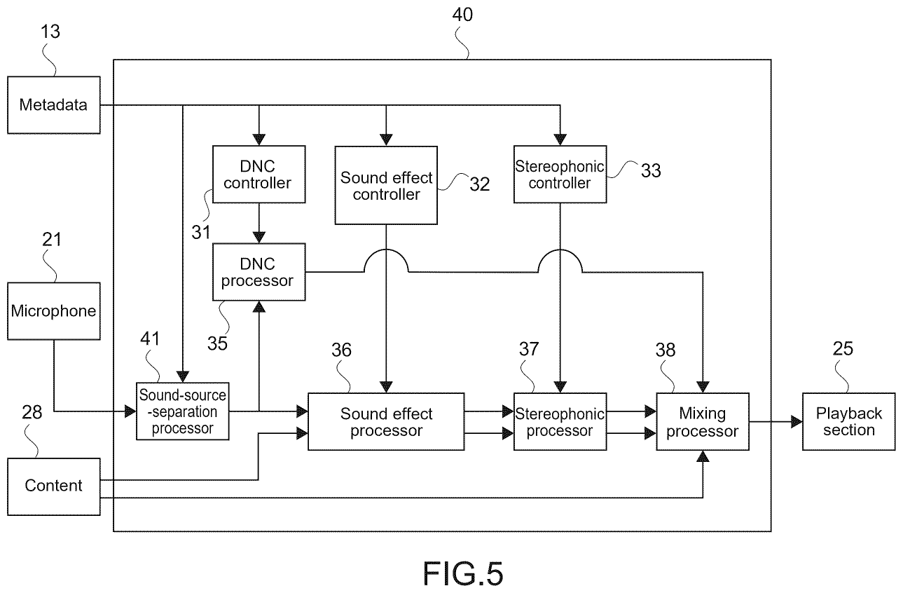

FIG. 5 is a block diagram of another example of a configuration of an external sound controller 40.

In the example illustrated in FIG. 5, sound source separation is used for external sound in which various kinds of sound coexist, where a label name is given to each sound waveform that forms the external sound. For example, various labels for, for example, the type of instrument, sound of talks, danger sound, announcement sound, a voice of a particular person, external sound suitable for content, sound that a user wants to hear, and a degree of priority, are given.

In the present embodiment, control is performed on the basis of a label for the type of sound source, the label being described in metadata. This makes it possible to control, for each type of sound source, sound desired to be heard by a user, and sound of which a level is desired to be reduced.

As illustrated in FIG. 5, the external sound controller 40 includes a sound-source-separation processor 41.

The sound-source-separation processor 41 performs sound source separation on external sound acquired from the microphone 21, and gives a label name to each sound waveform obtained by the separation, on the basis of the metadata 13. Note that, in the present embodiment, the sound source separation is performed using deep learning. Of course, the sound source separation may be performed using an approach other than deep learning.

Further, the metadata 13 in the present embodiment includes a label name given to each of the separated sound sources. The DNC processor 35 determines a degree of reducing a level of external sound for each of the separated sound sources, using, as metadata, a parameter set for each label name. Further, the sound effect processor 36 determines a parameter for a sound effect for each of the separated sound sources, using, as metadata, a parameter set for each label name. Furthermore, the stereophonic processor 37 determines a parameter for stereophonic control for each of the separated sound sources, using, as metadata, a parameter set for each label name.

When the label name for a separated sound source is sound of talks, sound pressure or volume is controlled. For example, sound of talks is enhanced by sound pressure (or volume) of the sound of talks being controlled to be high, and sound pressure (or volume) of ambient noise other than the sound of talks is controlled to be low. This enables the user to easily listen to the sound of talks.

When the label name for a separated sound source is danger sound, a position at which the sound is provided is changed by stereophony. For example, control is performed such that danger sound is heard close to an ear of a user and such that sound other than the danger sound is heard at a distance from the user. This enables the user to easily notice the danger sound.

When the label name for a separated sound source is announcement sound, sound pressure or volume is controlled. For example, announcement sound is enhanced by sound pressure (or volume) of the announcement sound being controlled to be high, and sound pressure (or volume) of ambient sound other than the announcement sound is controlled to be low. This enables a user to easily listen to the announcement sound.

When the label name for a separated sound source is a voice of a particular person, sound pressure or volume is controlled. For example, a voice of a particular person is enhanced by sound pressure (or volume) of the voice of a particular person being controlled to be high, and sound pressure (or volume) of ambient sound other than the voice of a particular person is controlled to be low. This enables a user to easily listen to the voice of a particular person.

When the label name for a separated sound source is external sound suitable for content, sound pressure or volume is controlled. For example, external sound, such as sound of birds singing, that is suitable for content is enhanced by sound pressure (or volume) of the external sound suitable for the content being controlled to be high, and sound pressure (or volume) of sound, such as sound of a motorcycle, that is not suitable for the content is controlled to be low. This makes it possible to provide a greater sense of immersion to a user.

In addition to the examples described above, any combination, such as a combination of making sound of talks easy to hear, suppressing noise, and capturing environmental sound, or changing a position at which a certain sound source is provided, may be adopted.

The label name for a sound source may be a name other than the above-described sound of talks, danger sound, announcement sound, and external sound suitable for content. Further, a parameter other than the above-described sound pressure, volume, and position at which provision is performed by stereophony, may be set.

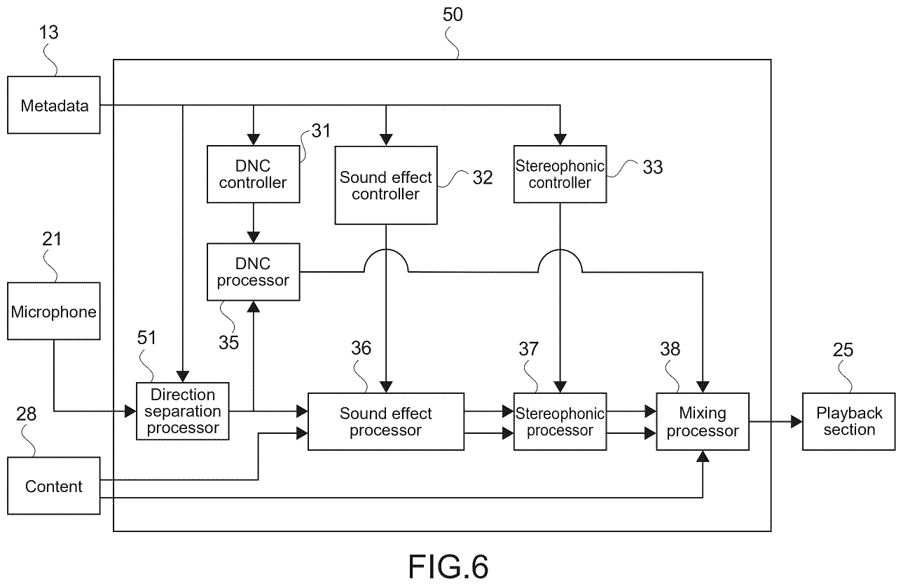

FIG. 6 is a block diagram of another example of a configuration of an external sound controller 50.

In the example illustrated in FIG. 6, control is performed on external sound acquired by the microphone 21, according to a direction that is based on the user 1 and in which the external sound is generated, that is, according to which direction the external sound is coming from. This makes it possible to perform control depending on the direction on the basis of control performed on sound for each of the angles described in metadata.

In the present embodiment, a device, such as an ambisonic microphone or a multi-array microphone, that can record sound around a user in all directions of 360 degrees is used as the microphone 21. Note that a method for estimating a direction of a sound source is not limited, and whether a sound source is in or outside of the field of view of a user may be estimated by image-capturing being performed by a camera.

As illustrated in FIG. 6, the external sound controller 50 includes a direction separation processor 51.

The direction separation processor 51 estimates a direction of external sound acquired by the microphone 21. For example, the direction separation processor 51 estimates a direction of external sound on the basis of the user 1, such as an upper, lower, right, left, or back side of the user 1. Further, a technology such as beamforming may be used to estimate the direction of external sound.

Further, the metadata 13 in the present embodiment includes a label name (such as an upper, lower, right, left, or back side) given for each direction of a sound source. The DNC processor 35 determines a degree of reducing a level of external sound, using, as metadata, a parameter set for each direction of a sound source. Further, the sound effect processor 36 determines a parameter for a sound effect, using, as metadata, a parameter set for each direction of a sound source. Furthermore, the stereophonic processor 37 determines a parameter for stereophonic control, using, as metadata, a parameter set for each direction of a sound source.

When, for example, the label name is a region in front (in the field of view) and outside of the field of view (in back), external sound in front of a user is enhanced, a level of external sound on a lateral side of the user is reduced, and external sound behind the user is enhanced. Further, for example, external sound outside of the field of view of a user may be enhanced to give priority to avoidance of danger.

Further, the present embodiment may be combined with the sound source separation described above. When, for example, the label name is traveling sound of a car and a lateral side (a direction from which the car is approaching), control is performed such that sound is heard from a direction from which the traveling sound is approaching a user and such that sound other than the traveling sound is heard at a distance from the user. This enables the user to easily notice danger sound.

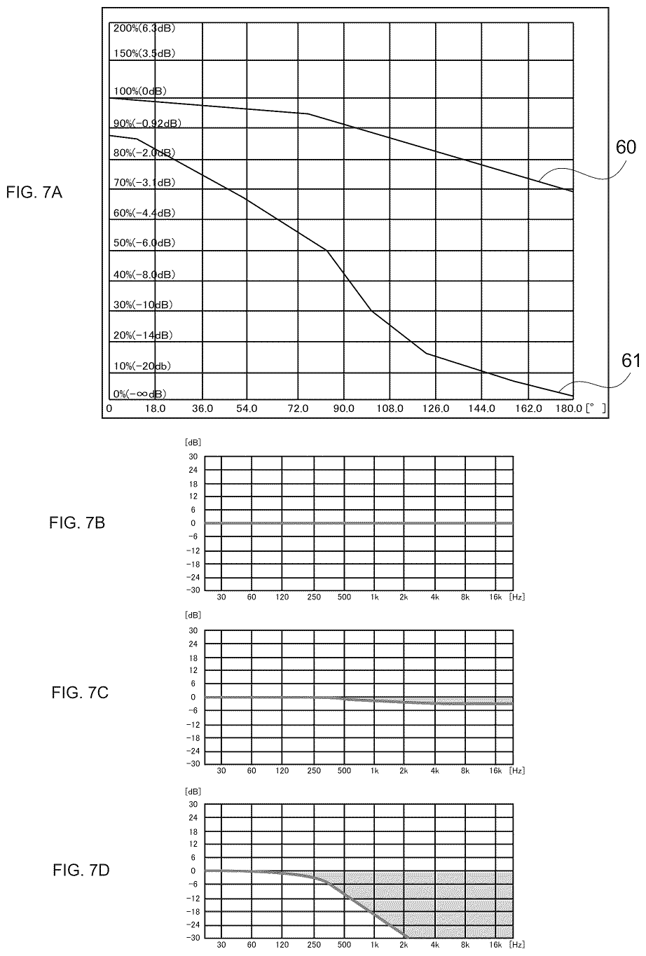

FIG. 7 schematically illustrates an example of control on external sound that is performed by direction separation.

A of FIG. 7 illustrates an example of sound control depending on an orientation of the user 1. As illustrated in A of FIG. 7, a vertical axis represents a change in sound pressure, and a horizontal axis represents an angle based on the user. In other words, 0 degrees on the horizontal axis represents a front side of the user 1, and 180 degrees on the horizontal axis represents a back side of the user 1.

A graph 60 indicates a change in sound pressure, and the sound pressure is controlled to be highest in front of the user 1 and controlled to be lowest behind the user 1. As illustrated in A of FIG. 7, a change in sound pressure is 0 dB at 0 degrees, and the sound pressure is reduced by −3.1 dB at 180 degrees. This enables the user 1 to recognize a change in sound that is caused depending on the orientation of the user 1.

A graph 61 indicates a strength of a high-pass filter, and control is performed such that sound pressure is reduced to be lowest in front of the user 1 and such that the sound pressure is reduced to be highest behind the user 1. As illustrated in A of FIG. 7, sound pressure is reduced to about 86% in front of the user 1, and is reduced to about 2% behind the user 1. This makes it possible to perform distinguishing by tone.

As illustrated in each of B to D of FIG. 7, a vertical axis represents a reduced amount of sound pressure (dB), and a horizontal axis represents a frequency (Hz). B of FIG. 7 illustrates a change in high-pass filter in front of the user 1.

C of FIG. 7 illustrates a change in high-pass filter on a lateral side of the user 1 (at, for example, 90 degrees).

D of FIG. 7 illustrates a change in high-pass filter behind the user 1 (at, for example, 180 degrees).

When sound pressure and a high-pass filter are combined according to a direction from which sound is heard, as described above, this makes it possible to provide sound while making sound from the front clear and maintaining a state in which sound is also heard from a direction other than the front.

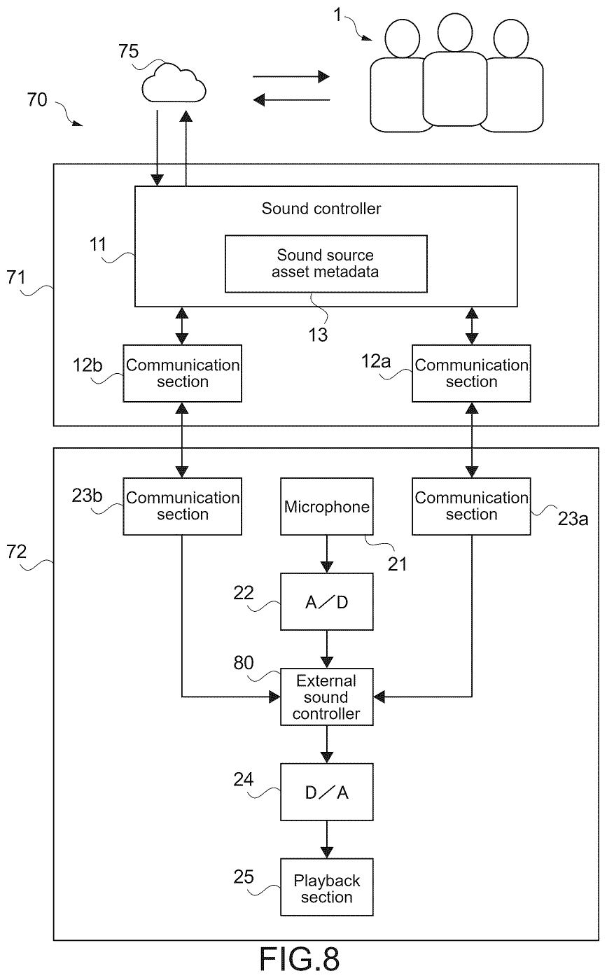

FIG. 8 is a block diagram of another example of a configuration of an information processing system 70.

In FIG. 8, it is assumed that, for example, a teleconference that enables users to have a talk remotely is used. In the present embodiment, sound of content is overlaid on a talk with a friend when experience in overlaying virtual sound on actual sound is provided. This results in interrupting the talk with the friend. Further, if earphones are taken off, playback is stopped, or the volume is turned down for a talk with a friend, this will result in losing a sense of immersion into content. Furthermore, when noise canceling earphones are used, there is a possibility that a user will not be aware of voices talking around the user.

Further, when a teleconference is used, it will be difficult to have a talk due to delay if users have a talk at a distance at which the users can see each other. Furthermore, it will be difficult to distinguish between sound of content and sound of a teleconference when the sound of content is overlaid on the sound of a teleconference.

Thus, in the present embodiment, an external sound controller 80 performs control to determine whether to use, for example, sound of a teleconference or external sound according to a distance between users. Further, control is performed such that a localization position for a voice of a person around a user (a sound source) and a localization position for a sound source of content do not overlap. Control may be performed to determine whether to use sound of a teleconference or external sound on the basis of a parameter other than the distance between users.

A talk held when control is performed using external sound, that is, a talk held by users situated close to each other is hereinafter referred to as a “proximity talk”. Further, control performed when a proximity talk is not held is represented as “normal”. For example, “metadata used for proximity talk” means metadata including a specific parameter used when a proximity talk is held. Further, for example, “normal metadata” means control performed when a proximity talk is not held, that is, control performed when the teleconference described above is not used.

As illustrated in FIG. 8, the information processing system 70 includes a mobile terminal 71 and earphones 72.

In the present embodiment, the users 1 have a talk with each other through a network 75. Specifically, a voice of the user 1 is acquired by the microphone 21, and a microphone waveform (a waveform of sound of the user) from the earphones 72 is transmitted to the mobile terminal 71. Further, position information regarding a position of the user 1 is also transmitted and received.

Note that audio ducking control on sound of a teleconference and sound of content is assumed to be performed by the sound controller 11. Further, in addition to the microphone of the earphones 72, the microphone 21 according to the present embodiment may be a microphone included in the mobile terminal 71.

The audio ducking control refers to control performed to turn down the volume of sound other than primary sound upon output of the primary sound such that the other sound is less noticeable. When, for example, a user wants to concentrate on content, the volume of a talk may be turned down. Further, for example, the volume of content may be turned down as a result of determining that a user wants to concentrate on a talk with another user, on the basis of, for example, the vocal intonation and the volume of voice in the talk.

Further, in the present embodiment, a communication section 12a transmits a waveform of sound of content and the metadata 13 to a communication section 23a. Further, a communication section 23b transmits a waveform of sound of the user 1 (a waveform of sound acquired by the microphone 21) to a communication section 12b.

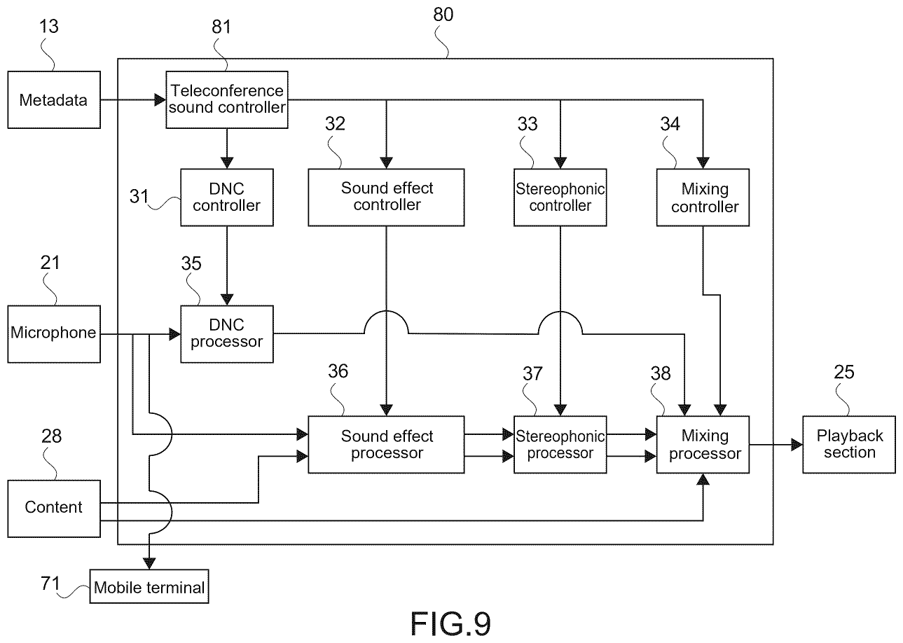

FIG. 9 is a block diagram of another example of a configuration of the external sound controller 80.

As illustrated in FIG. 9, the external sound controller 80 includes a teleconference sound controller 81.

On the basis of the metadata 13, the teleconference sound controller 81 controls a use parameter regarding whether external sound is to be captured since users situated close to each other have a talk, or external sound is not to be captured since the users remotely have a teleconference.

The microphone 21 transmits the acquired sound to the mobile terminal 71.

In the present embodiment, the DNC controller 31 controls a degree of adapting DNC on the basis of a use parameter output by the teleconference sound controller 81. Likewise, the sound effect controller 32, the stereophonic controller 33, and the mixing controller 34 perform control on the basis of a use parameter.

Further, in the present embodiment, examples of the metadata 13 include teleconference sound control, DNC control, and mixing control.

For example, a degree of applying a parameter used for proximity talk is set with respect to the teleconference sound control. When users are situated close to each other, capturing of external sound enables the users to have a talk. In this case, control is performed such that less strict control is performed on DNC and external sound captured by the microphone 21 is enhanced. When, conversely, users are situated at a distance from each other, the users have a talk by having a teleconference. In this case, control is performed such that normal control is performed on DNC and a voice of a user is heard by his/her talk partner without the voice of the user being interrupted by external sound.

Further, for example, to what extent sound pressure (dB) of external sound is reduced, or to what extent sound pressure of external sound for proximity talk is reduced is set with respect to the DNC control. Furthermore, a normal mixing parameter or a mixing parameter used for proximity talk is set with respect to the mixing control.

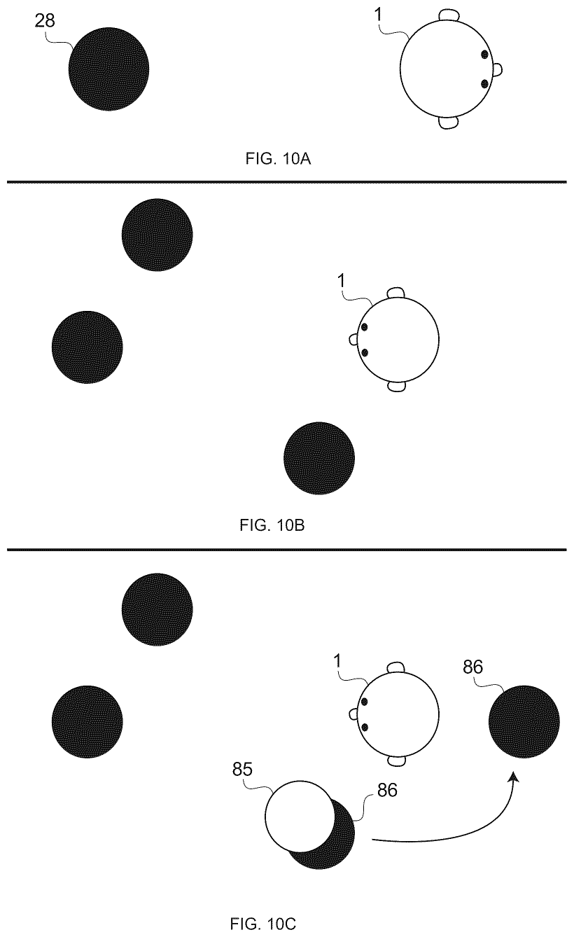

FIG. 10 schematically illustrates control performed on stereophony.

In the present embodiment, a positional relationship between a user having a teleconference or a proximity talk with his/her talk partner, and the talk partner is important for control performed on stereophony. Sound is localized using stereophony from a position at which the user 1 is actually situated, and this enables the user to intuitively understand who is talking from where. For example, the use of stereophony makes it possible to perform control such that the user 1 hears the content 28 from behind (refer to A of FIG. 10). Further, the use of stereophony makes it possible to easily distinguish between respective talks when there is a plurality of pieces of content or a plurality of talk partners (refer to B of FIG. 10).

Further, when a localization position 85 for sound in a talk (a voice of another user) and a localization position 86 for content overlap, control may be performed such that a position of the talk or a fixed position of the content is shifted to make it possible to easily distinguish between respective sounds (refer to C of FIG. 10). This enables a user to hear sound of a talk around the user while playing back narration of content. Further, for example, voices of participants may be prioritized according to the managerial position of the teleconference participant. In this case, control may be performed to preferentially enhance sound of a high-priority participant. In addition, when, for example, there is a user, from among teleconference participants, who uses a hearing-aid-related device such as a hearing aid or a sound collector due to, for example, hearing difficulty, the adoption of arrangement different from normal arrangement (adopted for people with good hearing) may be more effective. In this case, for example, localization positions for various kinds of sound may be adjusted for each individual on the basis of user information (such as a state in which a hearing aid is used, and hearing data) or device information (such as the type of device used and a model number of a used device). A localization position for a voice of a teleconference participant and a localization position for content may be set automatically on the basis of, for example, the above-described user information and device information, or may be set by a user. This makes it possible to perform optimal setting for each individual user.

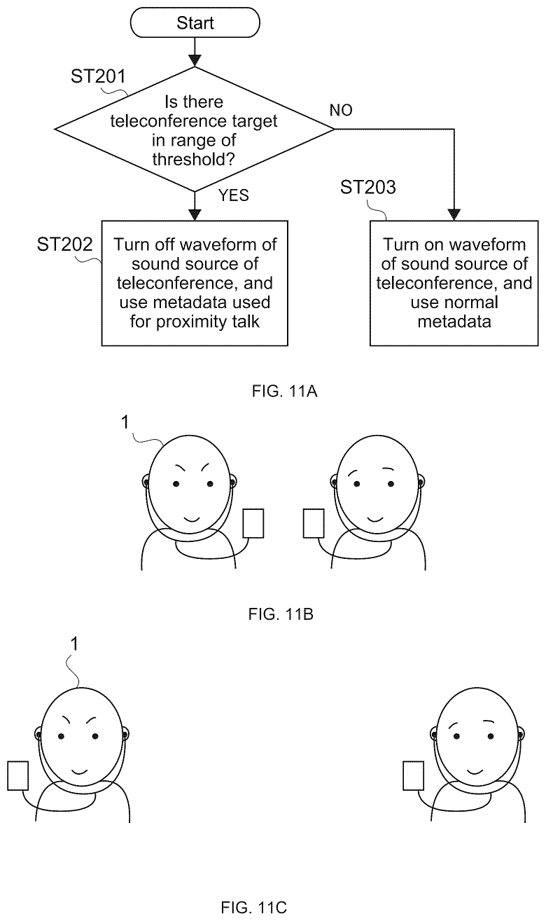

FIG. 11 illustrates control performed for a teleconference and a proximity talk. A of FIG. 11 is a flowchart illustrating an example of control performed to switch between a teleconference and a proximity talk. B and C of FIG. 11 schematically illustrate control performed to switch between a teleconference and a proximity talk.

It is determined whether there is a teleconference target in a range of a threshold for the user 1 (Step 201). For example, position information obtained by, for example, the Global Positioning System (GPS) may be used. Further, the threshold described above may be set automatically, or any value may be set by the user 1 to be the threshold.

When it has been determined that there is a teleconference target in the range of the threshold (YES in Step 201), the teleconference sound controller 81 turns off a waveform of a sound source of the teleconference, and uses metadata used for proximity talk (Step 202).

When a distance between users is less than a specified threshold, as illustrated in B of FIG. 11, the users have a talk by external sound being captured. In other words, control is performed such that less strict control is performed on DNC and sound acquired by the microphone 21 is enhanced.

When it has been determined that there is no teleconference target in the range of the threshold (NO in Step 201), the teleconference sound controller 81 turns on the waveform of the sound source of the teleconference, and uses normal metadata (Step 203).

When a distance between users is greater than the specified threshold, as illustrated in C of FIG. 11, the users have a talk by having a teleconference. In this case, control is performed such that control on DNC and control on a degree of capturing external sound that is performed by the microphone 21 are normally performed and a voice of a user is heard by his/her talk partner without the voice of the user being interrupted by the external sound.

This makes it possible to concentrate on content while enjoying a talk with a friend. Further, there is no need to take off earphones every time content is played back irregularly during a talk. Further, a proximity talk is not affected by delay since a teleconference is turned off during the proximity talk.

Note that metadata may be set discretionarily by the user 1. For example, control on an amount of audio ducking performed with respect to sound in a talk may be performed such that the volume of a talk of a talk partner is turned down when the user 1 wants to concentrate on content, or such that the volume of the talk is turned up when the user 1 is ready for the talk. Further, when, for example, the user 1 does not want to hear impressions on or a talk about content, control may be performed such that the talk is not heard. The controls described above may be automatically performed on the basis of details set in advance, or a voice of a user (such as “turn down the volume of sound of content since I want to have a talk with my friend”) may be received using, for example, a sound recognition technology and control may be performed on the basis of the received voice.

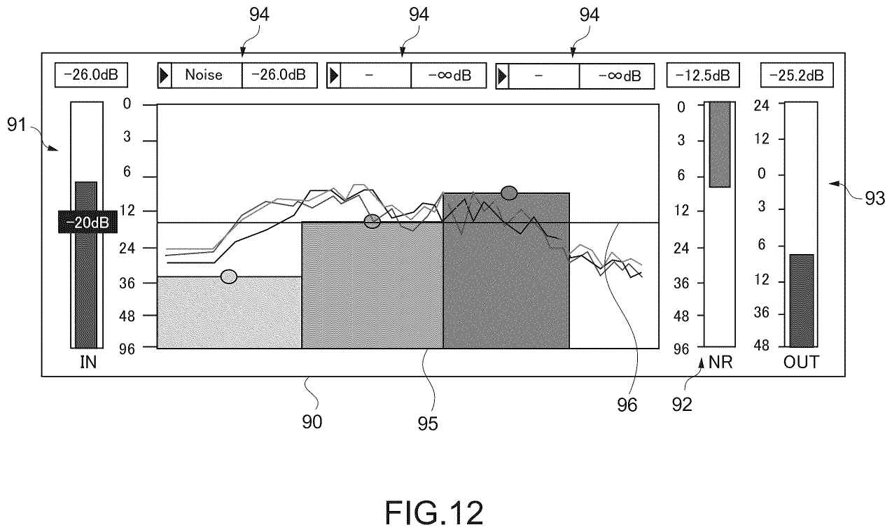

FIG. 12 schematically illustrates a graphical user interface (GUI) used to create a waveform for noise canceling.

As illustrated in FIG. 12, a GUI 90 includes an external sound input section 91, a noise reduction section 92, an external sound output section 93, a target setting section 94, and a waveform display section 95.

The external sound input section 91 displays thereon external sound to be input, an input gain, and an overall threshold. In FIG. 12, a threshold of −20 dB is set in the external sound input section 91, and setting is performed such that an effect is provided for external sound (−26.0 dB) exhibiting a value greater than or equal to the value of the threshold. Further, the external sound input section 91 may include a function such as sidechain compression (side chain comp) in which an input source is added and operation is performed by being triggered by sound other than sound on an inserted truck. Accordingly, a function of dynamically changing a threshold using levels of simultaneously provided sounds may be included.

The noise reduction section 92 displays thereon a level at which reduction is being performed. FIG. 12 illustrates a positive (+) level indicating that reduction is being performed, and a final output level is displayed.

The external sound output section 93 displays thereon a level of external sound to be output.

The target setting section 94 can set the type of sound of which a level is desired to be reduced. For example, various kinds of sound such as noise including a throng and voices, and traveling sound of a car can be set. In addition to this, sound extracted using, for example, AI may be selectable as a target. In FIG. 12, three kinds of sound and values with which reduction is to be performed can be set, although the type of sound of which a level is to be reduced, and the number of the sounds are not limited thereto.

The waveform display section 95 displays thereon an input waveform and a threshold (a straight line 96). In FIG. 12, three waveforms are displayed. Note that displayed details are not limited, and anything that enables, for example, a degree of reduction and a difference in reduction to be recognized may be displayed.

Note that the functions of the GUI 90 are not limited thereto, and various settings may be performed. For example, a target may be settable for each frequency, or a value for cancellation may be changeable for each area, or a reduction level may be changeable for each band.

As described above, the earphones 20 according to the present embodiment control ambient external sound around the user 1 on the basis of the metadata 13 related to the external sound, the metadata 13 being added to the content 28 played back according to user information regarding the user 1. This makes it possible to provide high-quality listening experience.

Conventionally, external sound may interrupt when virtual sound is overlaid on actual sound. For example, it is difficult to hear sound from earphones in a noisy state such as an intersection with large volumes of traffic or an event site, and this results in a reduction in a sense of immersion that is provided by virtual sound. Further, when canal earphones or a noise canceling technology is used, a talk of a person who enjoys experience together will not be heard, and there will be a need to take off the earphones every time the person talks. This results in interfering with experience. Further, when noise canceling is performed at all times, this results in difficulty in having experience in having a good time while securing safety and having a talk with friends. Furthermore, it is difficult to automatically recognize, upon controlling noise canceling, a state in which external sound is to be controlled. It is not easy to control external sound at a timing intended by a creator.

According to the present technology, the addition of metadata to content makes it possible to control ambient external sound on the basis of metadata when content is played back. Further, when content, such as narration or notice sound, that is desired to be heard by a user is played back, audio ducking is performed with respect to external sound, and this enables the content to be played back without being affected by the external sound. Further, experience intendedly utilizing external sound can also be provided.

### Other Embodiments

The present technology is not limited to the embodiments described above, and can achieve various other embodiments.

In the embodiments described above, the degree of reducing a level of external sound, the sound effect processing, the stereophonic control, the mixing control, and the teleconference sound control are set to be metadata. Without being limited thereto, the metadata may be set according to any state or application.

For example, a parameter in metadata may be linked to an external application programming interface (API) to be dynamically controlled. Specifically, a level of external sound to be captured may be changed in content according to an API used to report weather forecast and a traffic condition. Further, external sound (such as sound of rain or thunder) may be captured by settings of content and weather being combined. Furthermore, control may be performed such that there is a change in footstep upon, for example, rain or snow prediction, or preset sound may be reproduced upon thunder prediction. Moreover, content suitable for weather, such as music related to rain or snow, may be played back.

Further, for example, a parameter in metadata may be dynamically controlled according to a position of a user or the behavior of the user. Specifically, according to, for example, the movement of a head of a user, a sound effect may be changed or a position of a sound source upon performing stereophonic processing may be controlled. The movement of a user may be acquired using, for example, an acceleration sensor or a gyroscope. A method for acquiring the movement of a user is not limited thereto, and the movement of a user may be acquired using any other methods. A state or an emotion (such as being relaxed and being concentrating) of a user can also be sensed using a biological sensor such as a blood pressure sensor or a pulse sensor. On the basis of the user's state or emotion acquired as described above, a parameter in metadata, sound of content, and external sound may be dynamically controlled.

Further, for example, an intention of a user (behavior desired by the user) may be estimated, and a parameter in metadata may be dynamically controlled. Specifically, the intention of whether the user wants to or does not want to hear sound may be estimated, and a level of external sound to be captured may be changed. Note that a method for estimating an intention of a user is not limited, and the intention may be estimated using, for example, pulse, a line of sight, or a voice of a user.

In this case, the label name for a separated sound source is set to be sound that the user wants to hear, and sound pressure or volume is controlled. For example, the sound the user wants to hear is enhanced by sound pressure (or volume) of the sound the user wants to hear being controlled to be high, and sound pressure (or volume) of external sound other than the sound the user wants to hear is controlled to be low. This enables the user to easily hear sound desired by the user and talk details.

Further, a parameter may be dynamically changed according to the specifications of the mobile terminal 10 or the earphones 20 of a user. Specifically, when the user uses the earphones with which the user can hear low-frequency sound, pretty strict control may be performed on a reduction in low-frequency noise. Further, a degree of priority given to processing may be changed according to the remaining battery life of the mobile terminal 10 or the earphones 20.

In the embodiments described above, the microphone 21 is included in the earphones 20. Without being limited thereto, control on external sound may be performed by the mobile terminal 10 or cloud when a device that does not include the microphone 21 is used. Further, one microphone or a plurality of microphones may be provided. When a plurality of microphones is provided, types of the plurality of microphones may be different.

In the embodiments described above, content related to a walk around the theme park 2 is used. Without being limited thereto, the present technology may be applied to content corresponding to daily life. For example, control may be performed according to, for example, a position of a user or a state around the user such that external sound, such as sound of wind or a song of a bird, that is heard upon approaching forest is captured. Further, for example, control may be performed such that external sound such as a warning beep or sound of traveling is captured when an alarm of a level crossing signal is being beaten, or when a train is passing, or when the time for a train to pass is approaching.

Further, control may be performed such that external sound is not heard. For example, control may be performed such that everyday sounds, such as announcement sound and sound of a train, that are familiar to a user are not heard when the user is on a platform. Furthermore, for example, control may be performed such that external sound such as sound of an airplane that is not suitable for the situation is not heard during walking in forest.

In addition to the examples described above, control may be performed on external sound according to various situations when content is being heard. For example, control may be performed such that only a voice of a particular person such as a staff member of a shop is heard. Further, for example, control may be performed such that only high-urgency sound such as a call or a scream is heard. Furthermore, for example, control may be performed such that talk details that interest a user are heard. Settings described as metadata in advance may be used for a degree of priority of sound and a degree of urgency of the sound, or the degree of priority of sound and the degree of urgency of the sound may be changed by a user as appropriate.

In the embodiments described above, content is played back according to position information regarding a position of a user. Without being limited thereto, control may be performed on content according to various information regarding the user. For example, a speed of playback of content may be controlled according to a speed at which the user walks.

Further, for example, a degree of capturing external sound, a position of a sound source, and a degree of audio ducking performed on the external sound and content may be controlled finely in a timeline of the content.

In the embodiments described above, control is performed using a flowchart adopted when there exists metadata used for DNC control. In addition to this, determination may be performed by whether there exists metadata used for sound effect control, metadata used for stereophonic control, or metadata used for mixing control.

For example, it may be determined, as Step 101, whether there exists metadata used for sound effect control. Further, it is determined, as Step 102, whether sound effect control can be performed using a device. Furthermore, when it has been determined that sound effect control can be performed using the device, a sound effect may be determined, as Step 103, on the basis of the metadata. Further, as Step 104, sound effect processing may be performed and an external sound capturing waveform may be generated.

The respective configurations of the external sound controller, the DNC processor, and the teleconference sound controller; the control flow of the communication system; and the like described with reference to the respective figures are merely embodiments, and any modifications may be made thereto without departing from the spirit of the present technology. In other words, for example, any other configurations or algorithms for purpose of practicing the present technology may be adopted.

Note that the effects described in the present disclosure are not limitative but are merely illustrative, and other effects may be provided. The above description of the plurality of effects does not necessarily mean that the plurality of effects is provided at the same time. The above description means that at least one of the effects described above is provided depending on, for example, a condition. Of course, there is a possibility that an effect that is not described in the present disclosure will be provided.

At least two of the features of the respective embodiments described above can also be combined. In other words, the various features described in the respective embodiments may be combined discretionarily regardless of the embodiments.

Note that the present technology may also take the following configurations.
(1) An information processing apparatus, including a controller that controls ambient external sound around a user on the basis of metadata related to the external sound, the metadata being added to content played back according to user information regarding the user.
(2) The information processing apparatus according to (1), in which
   the metadata includes at least one of a parameter related to sound pressure, a parameter related to a sound effect, a parameter related to stereophony, a parameter related to mixing, a label name given to the type of sound, or a parameter related to a direction of a sound source.
(3) The information processing apparatus according to (2), in which
   the controller performs at least one of control based on the metadata to reduce sound pressure of the external sound, control on the sound effect according to the content, or control on a position of a sound source of the external sound.
(4) The information processing apparatus according to (3), in which
   the parameter related to stereophony includes a position of a sound source of the content and the position of the sound source of the external sound, and
   the controller performs control such that the position of the sound source of the content and the position of the sound source of the external sound do not overlap.
(5) The information processing apparatus according to (1), in which
   the controller controls sound pressure according to the type of the external sound on the basis of the metadata.
(6) The information processing apparatus according to (5), in which
   the label name includes at least one of sound of talks, sound of great danger for the user, announcement sound, a voice of a particular person, or sound suitable for the content, and
   the controller performs control such that sound pressure of at least one of the sound of talks, the great-danger sound, the announcement sound, the voice of the particular person, or the sound suitable for the content is increased and such that sound pressure of external sound other than at least one of the sound of talks, the great-danger sound, the announcement sound, or the voice of the particular person is reduced.
(7) The information processing apparatus according to (2), in which
   when the type of sound corresponds to sound of great danger for the user, the controller is controlled on the basis of the metadata such that the sound is heard from a direction in which the sound is situated.
(8) The information processing apparatus according to (2), in which
   the controller controls sound pressure according to a direction of a sound source of the external sound on the basis of the metadata.
(9) The information processing apparatus according to (8), in which
   the direction of the sound source includes a region in front of the user and a region outside of a field of view of the user, and
   the controller performs control such that sound pressure of sound provided from the region in front of the user is increased and such that sound pressure of sound provided from the region outside of the field of view is reduced.
(10) The information processing apparatus according to (2), in which
   the metadata includes control on an application that enables a plurality of users to remotely have a talk with each other, and
   the controller executes or stops the application on the basis of a distance between the users of the plurality of the users.
(11) The information processing apparatus according to (10), in which
   when the distance between the users of the plurality of the users is less than a specified threshold, the controller stops the application, and performs control such that sound pressure of the external sound including voices of the plurality of the users is increased.
(12) The information processing apparatus according to (2), further including
   a metadata controller that dynamically controls the metadata on the basis of at least one of device information regarding a device of the user or the user information.
(13) The information processing apparatus according to (12), in which
   the device information includes at least one of an application executed by the device, the remaining battery life of the device, or capacity of the device.
(14) The information processing apparatus according to (2), in which
   the user information includes at least one of an intention of the user, a position of the user, or behavior of the user.
(15) The information processing apparatus according to (14), in which
   the intention of the user includes the type of sound desired by the user, and
   the controller performs control such that sound pressure of the sound desired by the user is increased and such that sound pressure of the external sound other than the sound desired by the user is reduced.
(16) The information processing apparatus according to (14), in which
   the controller performs control on the basis of the position of the user such that sound pressure of the external sound corresponding to an environment around the user is increased and such that sound pressure of the external sound other than the external sound corresponding to the environment around the user is reduced.
(17) The information processing apparatus according to (1), in which
   the controller changes the metadata on the basis of at least one of an intention of the user, a position of the user, or behavior of the user.
(18) An information processing method that is performed by a computer system, the information processing method including
   controlling ambient external sound around a user on the basis of metadata related to the external sound, the metadata being added to content played back according to user information regarding the user.
(19) A program that causes a computer system to perform a process including
   controlling ambient external sound around a user on the basis of metadata related to the external sound, the metadata being added to content played back according to user information regarding the user.
(20) An information processing system, including:
   a mobile terminal that includes
      an acquisition section that acquires content, and
      a playback controller that plays back the content on the basis of user information regarding a user; and
   an information processing apparatus that includes a controller that controls ambient external sound around the user on the basis of metadata that is related to the external sound and added to the content.

### REFERENCE SIGNS LIST

5 information processing system
10 mobile terminal
20 earphones
30 external sound controller
41 sound-source-separation processor
51 direction separation processor
81 teleconference sound controller

1. An information processing apparatus, comprising
a controller that controls ambient external sound around a user on a basis of metadata related to the external sound, the metadata being added to content played back according to user information regarding the user.

2. The information processing apparatus according to claim 1, wherein
the metadata includes at least one of a parameter related to sound pressure, a parameter related to a sound effect, a parameter related to stereophony, a parameter related to mixing, a label name given to the type of sound, or a parameter related to a direction of a sound source.

3. The information processing apparatus according to claim 2, wherein
the controller performs at least one of control based on the metadata to reduce sound pressure of the external sound, control on the sound effect according to the content, or control on a position of a sound source of the external sound.

4. The information processing apparatus according to claim 3, wherein
the parameter related to stereophony includes a position of a sound source of the content and the position of the sound source of the external sound, and
the controller performs control such that the position of the sound source of the content and the position of the sound source of the external sound do not overlap.

5. The information processing apparatus according to claim 1, wherein
the controller controls sound pressure according to the type of the external sound on the basis of the metadata.

6. The information processing apparatus according to claim 5, wherein
the label name includes at least one of sound of talks, sound of great danger for the user, announcement sound, a voice of a particular person, or sound suitable for the content, and
the controller performs control such that sound pressure of at least one of the sound of talks, the great-danger sound, the announcement sound, the voice of the particular person, or the sound suitable for the content is increased and such that sound pressure of external sound other than at least one of the sound of talks, the great-danger sound, the announcement sound, or the voice of the particular person is reduced.

7. The information processing apparatus according to claim 2, wherein
when the type of sound corresponds to sound of great danger for the user, the controller is controlled on the basis of the metadata such that the sound is heard from a direction in which the sound is situated.

8. The information processing apparatus according to claim 2, wherein
the controller controls sound pressure according to a direction of a sound source of the external sound on the basis of the metadata.

9. The information processing apparatus according to claim 8, wherein
the direction of the sound source includes a region in front of the user and a region outside of a field of view of the user, and
the controller performs control such that sound pressure of sound provided from the region in front of the user is increased and such that sound pressure of sound provided from the region outside of the field of view is reduced.

10. The information processing apparatus according to claim 2, wherein
the metadata includes control on an application that enables a plurality of users to remotely have a talk with each other, and
the controller executes or stops the application on a basis of a distance between the users of the plurality of the users.

11. The information processing apparatus according to claim 10, wherein
when the distance between the users of the plurality of the users is less than a specified threshold, the controller stops the application, and performs control such that sound pressure of the external sound including voices of the plurality of the users is increased.

12. The information processing apparatus according to claim 2, further comprising
a metadata controller that dynamically controls the metadata on a basis of at least one of device information regarding a device of the user or the user information.

13. The information processing apparatus according to claim 12, wherein
the device information includes at least one of an application executed by the device, the remaining battery life of the device, or capacity of the device.

14. The information processing apparatus according to claim 2, wherein
the user information includes at least one of an intention of the user, a position of the user, or behavior of the user.

15. The information processing apparatus according to claim 14, wherein
the intention of the user includes the type of sound desired by the user, and
the controller performs control such that sound pressure of the sound desired by the user is increased and such that sound pressure of the external sound other than the sound desired by the user is reduced.

16. The information processing apparatus according to claim 14, wherein
the controller performs control on a basis of the position of the user such that sound pressure of the external sound corresponding to an environment around the user is increased and such that sound pressure of the external sound other than the external sound corresponding to the environment around the user is reduced.

17. The information processing apparatus according to claim 1, wherein
the controller changes the metadata on a basis of at least one of an intention of the user, a position of the user, or behavior of the user.

18. An information processing method that is performed by a computer system, the information processing method comprising
controlling ambient external sound around a user on a basis of metadata related to the external sound, the metadata being added to content played back according to user information regarding the user.

19. A program that causes a computer system to perform a process comprising
controlling ambient external sound around a user on a basis of metadata related to the external sound, the metadata being added to content played back according to user information regarding the user.
